(19) United States
(12) Patent Application Publication
(10) Pub. No.: US 2006/0248759 A1
(43) Pub. Date: Nov. 9, 2006

(54) Method and apparatus for concealing and/or improving the appearance of televisions and other displays

(76) Inventor: Arthur Moshlak, Millerton, NY (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 11/402,081

(22) Filed: Apr. 11, 2006

Related U.S. Application Data
(60) Provisional application No. 60/670,129, filed on Apr. 11, 2005.

(51) Int. Cl. G09F 11/00

(52) U.S. Cl. 40/489

(57) ABSTRACT

Methods and apparatus are disclosed for improving the appearance of a visual display, such as a television receiver or computer monitor, when not in use. A decorative surface is provided that is capable of displacement between a first condition in which it covers at least the display area when the display is not in use, and a second condition in which the decorative surface is displaced beyond the display area when the latter is in use. Various embodiments and improvements are disclosed.

This application claims priority to U.S. Provisional Application Ser. No. 60/670,129, filed Apr. 11, 2005, the entire disclosure of which is hereby incorporated by reference.

### FIELD OF THE INVENTION

This application relates to a method and apparatus for concealing and/or improving the appearance of televisions and other displays.

### BACKGROUND OF THE INVENTION

Television receivers have become common in the United States and in most foreign countries in a wide range of residences and income ranges. Such receivers are mass-produced, using both tube and flat screen technologies

By definition, to permit comfortable viewing, such receivers or displays are prominently placed in a room, generally at eye level for persons seated or lying in the most comfortable location.

In addition, many homes (and other environments) include one or more personal computers having an associated display monitor, one also generally placed at a seated eye level.

Although these prominent locations are useful when the set or display is employed, they assure a distraction when it is not. Such sets and displays are mass-produced. Their viewing area is typically dark grey or black when not energized, and the housing that surrounds it is rarely available in more than a few generic colors or styles, seldom appropriate to the decor of the other items in the same room.

It has, therefore, long been desirable to provide a means to improve the aesthetics of and/or conceal the set or display when not in use.

Typically, this has been limited to items of furniture that enclose and conceal the set or monitor behind hinged doors. Because the set or monitor typically should be located at eye level to the viewer, this requires a relatively tall item of furniture, which may, itself, be more incongruous than the set or monitor itself, as well as representing a significant expense. Such large items of furniture are often limited in where they can be located in a room.

In some applications (for example, in hotel rooms) in which it is desirable that a television be viewable from different available viewing locations that are within a wide horizontal arc around the room (relative to the set's location), it is necessary that the set be rotated so as to come into substantial alignment with the horizontal axis to the viewer at each location. This is at odds with enclosing the television in an item of furniture. It has required that the item of furniture be equipped with a platform on which the television sits; that platform be mounted to the item of furniture by means of a system of drawer slides that permit horizontally displacing platform and set well outside the envelope of the item of furniture; and permit rotating the set relative to the platform, by means of a circular bearing. Such assemblies add considerably to the cost of the item of such furniture.

In high-end applications, it has also long been known to install the set in a recess in a wall, one which can be concealed by a panel that is displaced vertically to reveal the set. Such a solution is, clearly, very expensive to implement, requiring substantial permanent alterations to the building.

It, therefore, remains an object to provide a method of improving the aesthetics of and/or concealing a television set or display monitor.

### SUMMARY OF THE INVENTION

The applicant achieves this object by the use of a decorative surface that is used to cover at least the active area of the display when it is not in use, and that can be readily retracted or removed to reveal at least that active area for use.

In some embodiments, the decorative surface is supported by or from the housing of the set or display.

In other embodiments, it can be supported from another object that is proximate to the set or display, including but not limited to, a surface on which the set or display rests or a furnishing (such as a desk unit, room divider, wall unit, bookshelf) in which the set or display is housed.

### BRIEF DESCRIPTION OF THE DRAWINGS

FIG. 1 is a frontal view of a typical television receiver or monitor.

FIG. 2 illustrates a decorative surface that is retained by velcro or magnetic strips attached to a receiver or monitor housing.

FIG. 3 illustrates a decorative surface retained by suction cups or other means that attach to the display surface.

FIG. 4 illustrates a decorative surface that is rolled upwards and, once rolled, can be held in the raised position.

FIG. 5 illustrates a surface that is wrapped around a rod or roller that is supported from the display housing.

FIG. 6 illustrates surface that is wrapped around a rod or roller that is supported by brackets that attach to the front surface of the display housing.

FIG. 7 illustrates a decorative surface hung from a rod or track that extends along the top edge of the display housing.

FIG. 8 illustrates a decorative surface that can be gathered to one side of the display area in the manner of a curtain.

FIG. 9 illustrates a decorative surface that retracts into an upper housing, illustrated as part of a framework around the display.

FIG. 10 illustrates a decorative surface that is rotated to a storage position alongside the set or monitor housing.

FIG. 11 illustrates an embodiment in which the decorative surface retracts into a housing located above the set or monitor.

FIG. 12 illustrates an embodiment in which the decorative surface stores in a housing that can be attached to another object or structure that is adjacent to the set or monitor.

FIG. 13 illustrates an embodiment in which the housing rests upon a surface below the display area and is extended upwards.

### DETAILED DESCRIPTION

The applicant achieves the desired object with a concealing/decorative surface used to cover at least the active area of a display when not in use; and that can be readily retracted or removed to reveal at least that active area during its use.

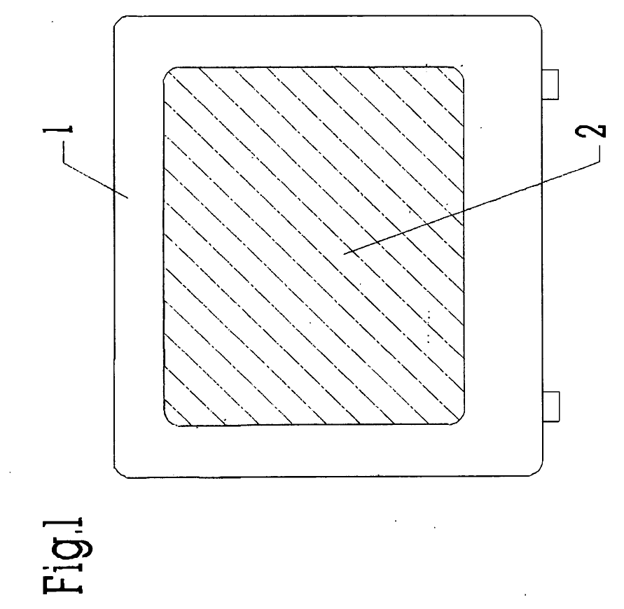

FIG. 1 illustrates a display 2 enclosed in a housing 1.

In some embodiments, the decorative surface is supported by or from the housing for the display.

In other embodiments, it can be supported from another object proximate to the display, including (but not limited to) a surface upon which the set or display rests, or a furnishing (such as a desk unit, room divider, wall unit, bookshelf) on or in which the set or display is accommodated.

In some embodiments, the decorative surface can be substantially rigid (or attached or applied to a rigid sub-panel), and removed by the user and set aside.

In other embodiments, it may hinge or rotate to one side or to the top and may be moveable towards the rear of the set or display.

The surface might be left in a position at an approximate right angle to the front surface of the set or display and partially extending beyond the plane of that surface for the purpose of blocking direct or ambient light that might degrade the viewing experience.

In other embodiments, the decorative surface may be rolled or folded into a storage position or condition. For example, with techniques as used in tambour doors; in “venetian” and other window blinds and curtains; and for roll-up window shades, large maps, and projection screens.

Once retracted into such a more compact storage position or condition, the mechanism, including the decorative surface, can be physically moved to another location or orientation or can remain on or at the set or display, so long as the active area of the tube or display surface is unobstructed during use.

For example, the decorative surface might retract into an elongated housing that is retained parallel to the top edge of the set or display housing, whether by attachment to the set or display or to an object or surface in proximity to it.

In any embodiment, the decorative surface and/or supporting, storage, and/or actuating elements may be retained to the set or display by a strap, bracket, spring, or elastic band that encircles the set or display.

Retraction or displacement of the decorative surface can be in any direction and by any means.

For example, the storage enclosure might sit below the set or display and the decorative surface might be extended upwards, attaching to the top edge of the set or display housing or being self-supporting. The storage enclosure might thus simply sit on a table, desk, shelf, or other horizontal surface also supporting the set or display, below and in front of the set or display. Flanges, legs, or other elements might extend under the set or display, with, perhaps, the set or display set atop them, the weight of the set or display preventing displacement of the storage enclosure, maintaining it and the decorative in proper alignment with the set or display.

The mechanism used to support and/or store the decorative surface can take many forms.

In addition to a substantially linear enclosure, the mechanism might be contained in a frame or bezel that surrounds at least the active area of the set or display. Such a frame or bezel approach may offer a rigid structure useful in supporting and deploying the structure. For example, it might be free-standing with little or no physical connection to the set or display. The frame may itself be a decorative element, and be offered in a variety of styles and finishes.

A frame or bezel or other housing and/or additional elements and/or surfaces may also extend “rearward” from the front surface of the set or display, such that it partially or completely covers the sides of the set or display housing.

The means used to attach the decorative surface and/or the mechanism used to deploy, support, and/or store it should not be understood as limited.

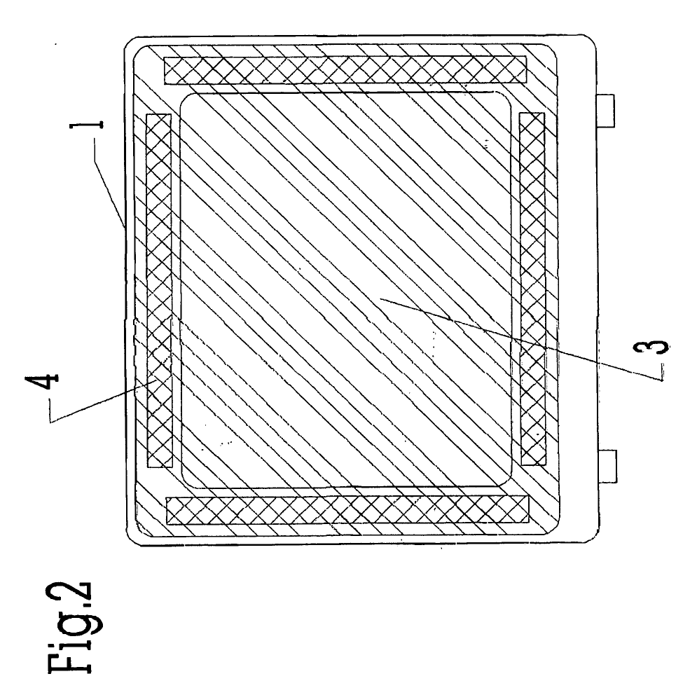

Generally, methods that do not involve permanent alteration (such as drilling and/or driving screws) will be preferred for attachment to the set or display. Magnets, suction cups, velcro, and double-sided tape are a few of the possible methods. FIG. 2 illustrates attachments 4 (that might be adhesive, “velcro”, magnetic strips, or other) for securing decorative surface 3 to housing 1.

In addition to attaching the decorative surface and/or the mechanism used to deploy, support, and/or store it to the housing of the set or display or to an adjacent object or surface, certain embodiments can be attached directly to the active area of the display, which offers a smooth surface suitable for some fastening methods.

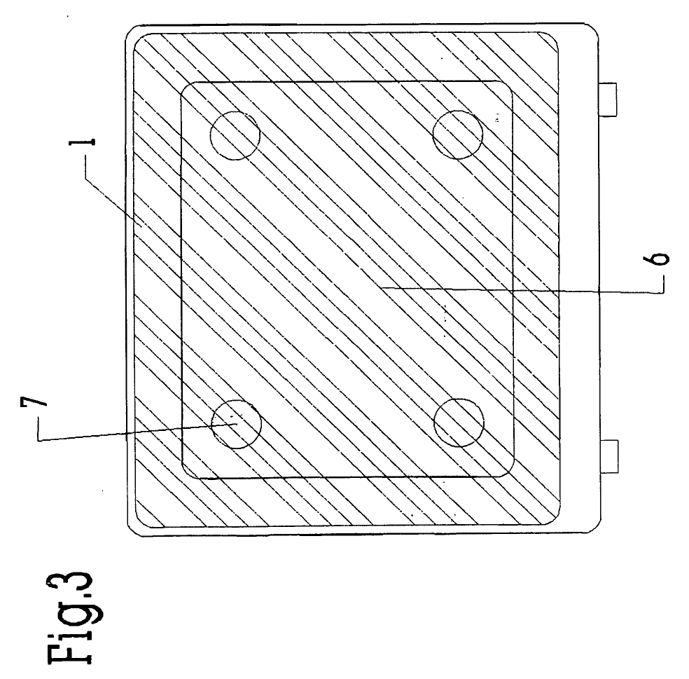

For example, suction cups would attach a decorative surface or a subpanel supporting it directly to the active area. FIG. 3 illustrates suction cups or other means 7 that attach decorative surface 6 to the display. The decorative surface, therefore, need only be sized with reference to the dimensions of the total area to be masked (which may be larger than the active area of the set or display screen), and no attachment to the set or display housing itself need be necessary.

A lip or flange that rests over the top edge of the set or display housing can assist in aligning the decorative surface; reduce shear forces on attachments; and may require little or no additional provisions for retention.

Magnets and magnetic strips are another candidate for attachments. Although most set and display housings are plastic, low-profile magnets or magnetic strips could be attached to the housing with adhesive. The magnets or magnetic strips would then interact with compatible surfaces or elements on the decorative surface or the panel, support, mechanism, and/or container associated with it.

“Soft” embodiments are also possible in which a rigid, semi-rigid, or flexible decorative surface is retained over at least the display surface by methods including a “cover”, “surround”, or “collar” that hangs, drapes, or is otherwise supported by the display housing, in some embodiments, including with the use of an elastic or drawstring member in its perimeter, similar in the most general principles, to a “shower cap”.

Importantly, the applicant's invention provides for a variety of possible decorative materials and appearances, such that a user could select or specify that most appropriate to their taste and decor.

Different materials, colors, textures, and finishes would be available for the decorative surface as well as for any mechanism, housing, or storage enclosure with it.

A frame or bezel, for example, could have different “dress panels” available.

Further, the decorative surface can include an image, whether a “stock” design or custom—including permitting the user to print a desired image either themselves or to send a print or electronic file to a manufacturing facility.

Because of the variations in the dimensions and proportions not only of the active area of sets and displays but of their housings, decorative surfaces and their mechanisms, supports, and storage enclosures should be orderable and/or adaptable to different dimensions. Some storage techniques (like rolling or accordion-folding the decorative surface) provide a measure of adjustment in the vertical dimension. Embodiments are also possible in which the decorative surface is composed of or applied to overlapping elements that are “shingled” or telescope, permitting a range of adjustment in the horizontal dimension as well.

Where manual actuation has been described, actuation can also be motorized, including by remote control, for example with the same remote control used for the set. Operation can also be made automatic, a photosensor responsive to activity on the display or monitor surface or a current sensor plugged in series with the set or monitor determining when the set or display is energized and retracting or extending the decorative surface as appropriate.

Various Figures illustrate some of the possible features and embodiments.

FIG. 1 is a frontal view of a typical television receiver or computer display/monitor. The display surface 2 is inset in a larger housing 1.

FIG. 2 illustrates a decorative surface 3 that is retained by velcro or magnetic strips 4 attached to the housing 1.

FIG. 3 illustrates a decorative surface 6 retained by suction cups 7 or other means that attach to the display surface.

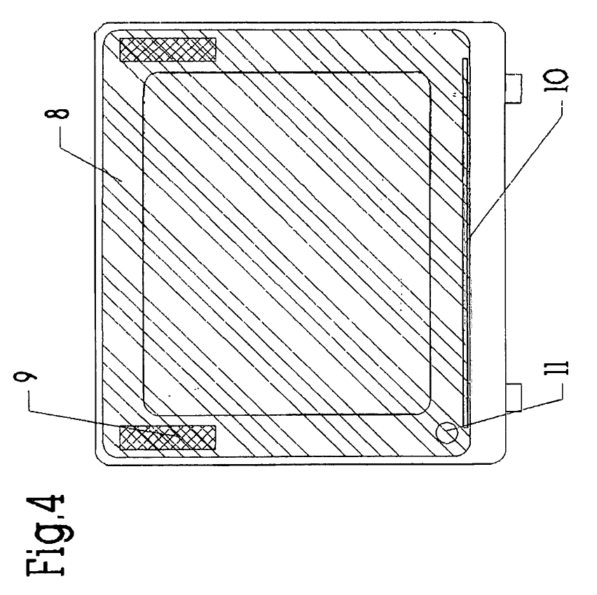

FIG. 4 illustrates a decorative surface 8 that is rolled or folded upwards and, once retracted, held in that position by tabs or loops 9. An optional rod 10 can be incorporated in the lower edge for stiffening and/or one or more magnetic or velcro fastener 11 used to fix the decorative surface to the housing. Either or both of these features can be used in this or any other embodiment.

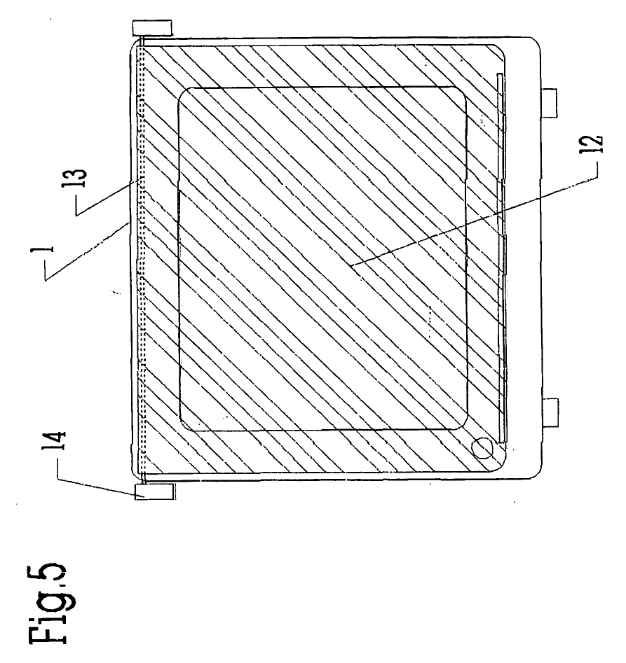

FIG. 5 illustrates a surface 12 that is wrapped around a rod or roller 13. The rod or roller is received by supports 14, which are illustrated as disposed on either side of the housing 1, where they might be attached to the housing itself, or they might be held in place by compression/clamping force against the sides of the housing 1.

In this or any other embodiments, retraction may be by manual means or motorized.

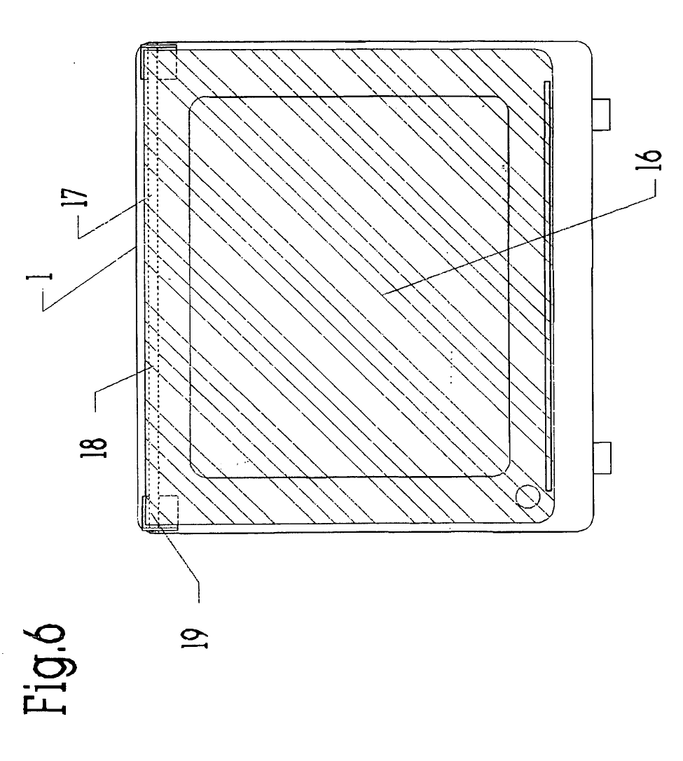

In FIG. 6, surface 16 is wound around a similar rod or roller 17 supported by brackets 19 that attach to the front (rather than the side) surface of the housing 1.

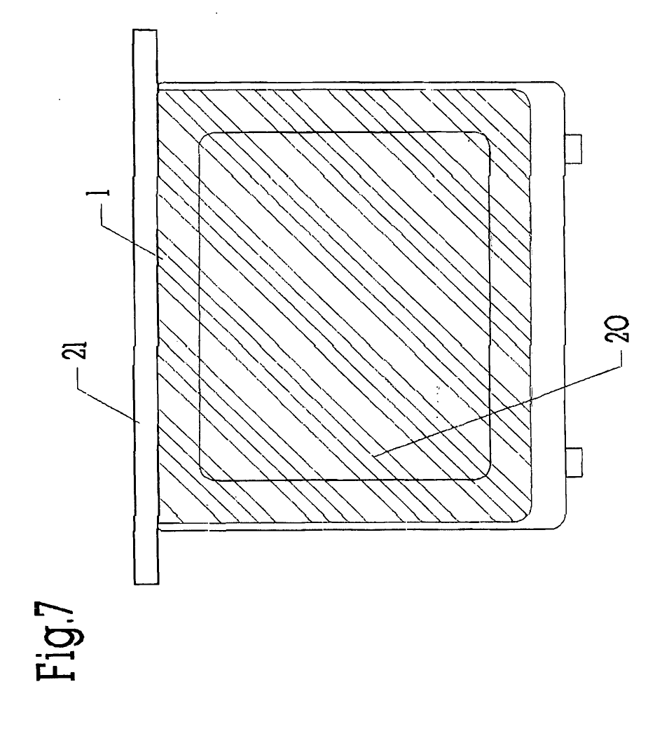

In FIG. 7, the decorative surface 20 is hung from a rod or track extending along the top edge of the housing 1, here illustrated as itself contained in a housing 21.

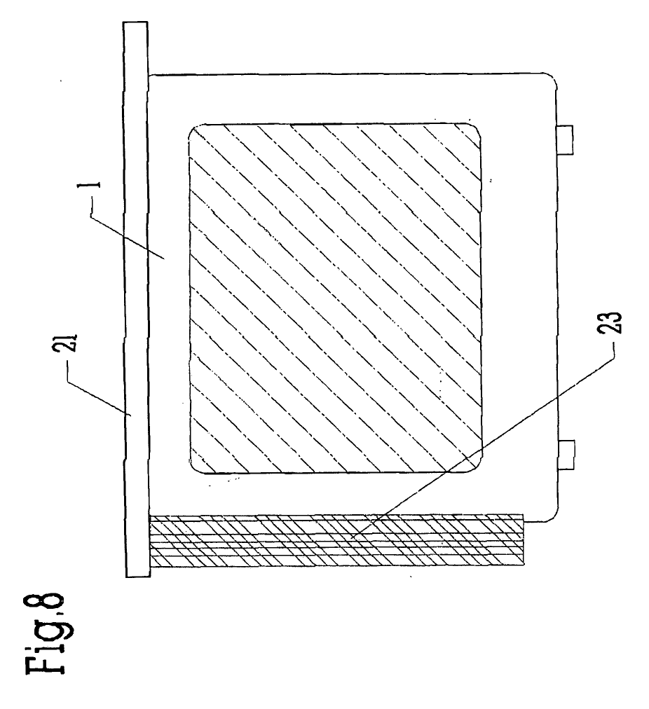

As illustrated in FIG. 8, a decorative surface 23 can be gathered to one side of the display area in the manner of a curtain.

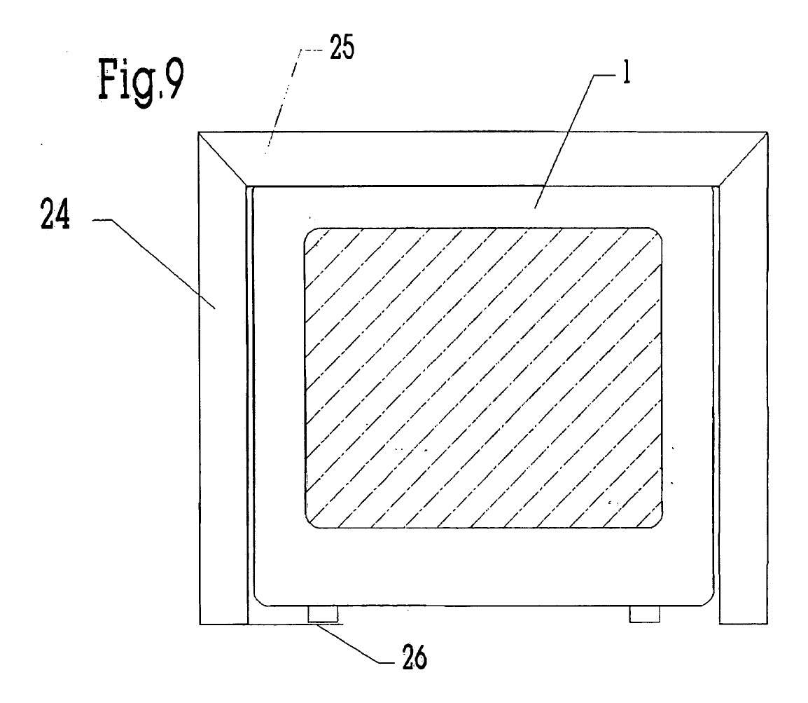

FIG. 9 illustrates a decorative surface that retracts into an upper housing 25. The upper housing 25 is supported as a part of a free-standing frame (including side 24) and need have little or no attachment to the housing 1 of the television set or monitor. The use of a foot or bracket 26 that extends under the set or monitor 1 and upon which the weight of the set or monitor 1 is applied to stabilize and/or align the decorative surface and/or its supporting, storage, and/or actuating elements is illustrated.

In this, or any other embodiment, additional decorative surfaces can extend parallel to the sides and/or top of the set or monitor.

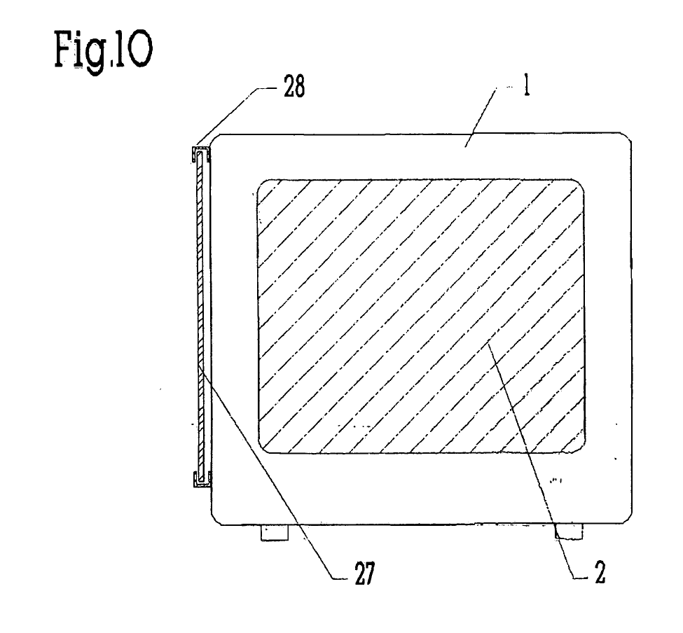

FIG. 10 illustrates a decorative surface 27 that, as illustrated, is displaced around the side of the set or monitor housing for storage. As previously described, the decorative surface (or an additional surface) can be used in a position that extends perpendicular and forward of the display surface as a sunshade or glare screen.

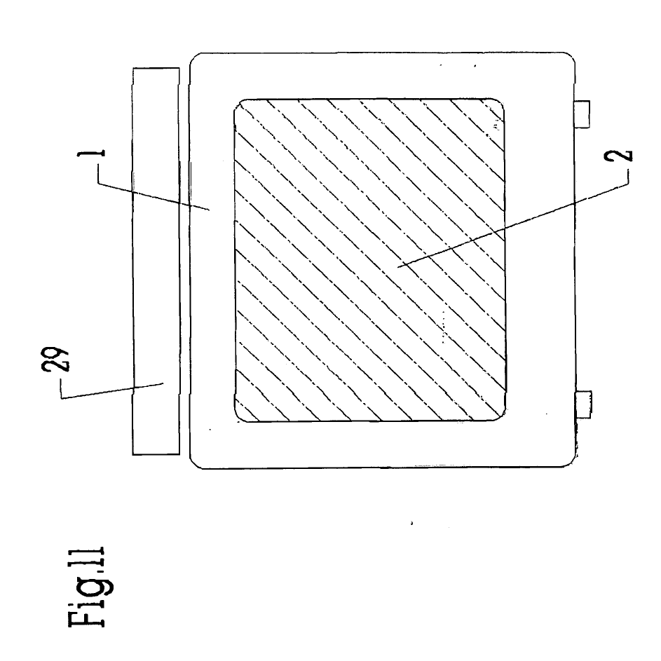

FIG. 11 illustrates an embodiment in which the decorative surface retracts into a housing 29, which rests atop or above the set or monitor housing 1, with or without a means of alignment or attachment.

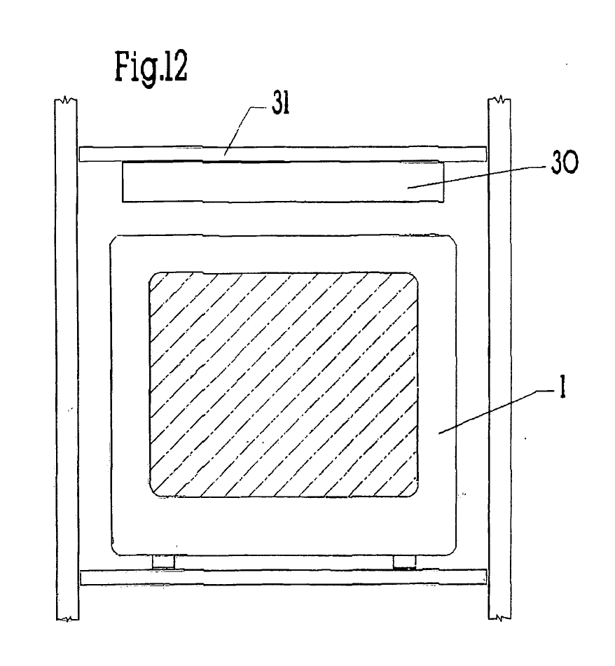

FIG. 12 illustrates an embodiment in which the decorative surface stores in a housing 30 that is attached to another object or structure adjacent to the set or monitor housing 1, in this case, to a shelf 31 above, in a bookcase or similar structure.

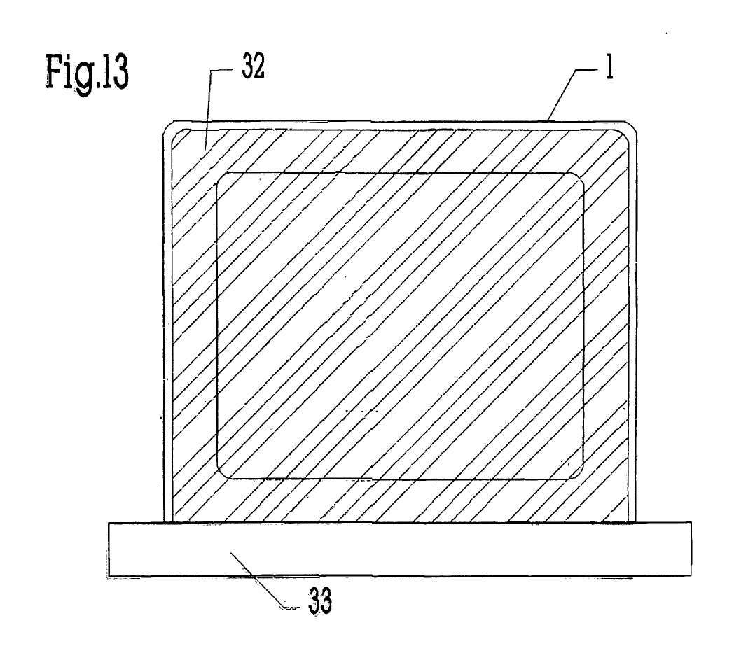

FIG. 13 illustrates an embodiment in which the housing 33 for surface 32 rests on a surface below the display area (typically the same surface upon which the set or monitor housing 1 also rests) and is extended upwards.

Although a number of approaches and embodiments have been disclosed herein, the scope of the invention should not be understood as limited except by the claims.

In addition, various of the approaches and improvements disclosed also have other potential applications.

For example, there is another, independent, long-felt need to temporarily mask or conceal the otherwise visible faces (and contents) of furnishings/features like wall units, bookshelves, and storage units. Absent substantial, built-in provisions (such as hinged, sliding, or tambour doors), there has been no practical method of improving their appearance. It should be understood that many of the techniques disclosed in the instant context of improving the appearance of receivers and displays also have potential application in providing alternatives to improve the appearance of such furnishings/features, including with optional or after-market retrofitable components that can be readily attached or used with such furnishings/features.

There is also a long-standing need to (at least visually) sub-divide areas in a dwelling or other space, for purposes including privacy, separation of functions, and/or appearance. Many of the techniques disclosed also have potential application therein.

What is claimed is:

1. Apparatus for selectively altering the appearance of at least a display to a viewer:
said display comprising a substantially planar visual display,
said display contained within a display housing,
said apparatus including an independent surface that may be deployed proximate and substantially parallel to said display area,
said surface occluding said display to said viewer and presenting an appearance different than said visual display when deployed,
said surface being capable of displacement between a first relationship with said display in which said surface is deployed proximate, substantially parallel, and occluding said display, and at least a second relationship in which said surface is relocated beyond said display.
